(19) United States
(12) Patent Application Publication
(10) Pub. No.: US 2026/0140556 A1
(43) Pub. Date: May 21, 2026

(54) CHIPLET-BASED SMART INTEGRATED COMPUTE SYSTEM

(71) Applicant: L&T Semiconductor Technologies Limited, Mumbai (IN)

(72) Inventors: Sandeep Kumar, Austin, TX (US); Peter Eyabi, Escondido, CA (US)

(73) Assignee: L&T Semiconductor Technologies Limited, Mumbai (IN)

(21) Appl. No.: 19/391,518

(22) Filed: Nov. 17, 2025

Related U.S. Application Data
(60) Provisional application No. 63/721,764, filed on Nov. 18, 2024.

(51) Int. Cl. G06F 1/3203; G05B 19/042

(52) U.S. Cl. CPC G06F 1/3203; G05B 19/042; G05B 2219/25257

(57) ABSTRACT

A chiplet-based smart integrated compute system includes a safe compute subsystem and a safe compute and safety monitoring subsystem linked by die-to-die interconnects for high-speed, low-latency, freedom-from-interference operation. Dedicated secondary storage subsystems, clock-generation subsystems (with crystal oscillators), and power-regulation subsystems (with pre-regulators) provide domain-specific memory, timing, and power. A safe smart power management subsystem with a microcontroller manages intelligent distribution, autonomous power-on/reset, over-the-air (OTA) updates to power-management integrated circuits, and selective isolation during faults. The microcontroller monitors thermal/electrical health and can selectively shut down a faulty domain. The safe compute subsystem may serve as a secure communication gateway to external electronic control units via a wireless link on a network, using a cryptographic processing unit with hardware-embedded keys. Diagnostic telemetry is transmitted to a cloud for predictive maintenance and policy refinement.

### TECHNICAL FIELD

The present disclosure relates to the field of electronic computing systems and multi-die integrated circuit packaging for safety-critical and secure embedded applications. More particularly, the present disclosure relates to a chiplet-based integrated compute and smart power management system resulting in a smart integrated compute platform.

### BACKGROUND

Modern embedded platforms for vehicles, industrial automation, and aerospace increasingly require high compute density, strong safety guarantees, and secure connectivity within tight power and latency budgets. Conventional vehicle electronic control units often assemble a monolithic system-on-chip with external volatile memory, power-management devices, and timing sources on a printed circuit board. Long off-chip traces, shared resources, and centralized gateways may introduce additional latency, increase power consumption, and create single points of failure that complicate certification and field maintenance.

In many implementations, safety-critical supervision resides in a “safety island” that still depends on shared memory paths, shared clocks, or shared power rails. Such coupling may degrade freedom from interference and can allow timing faults or power transients in one domain to ripple into another domain. When faults occur, existing platforms frequently resort to resetting the entire board-level assembly, which reduces availability and disrupts safety functions that ought to continue independently.

Power-management architectures used today are commonly fixed at integration time and may not support software-tunable limits or secure over-the-air servicing. As a result, scaling compute workloads or adapting to battery and thermal constraints in the field can be difficult. Similarly, relying on external microcontrollers for power-on and reset sequencing may add latency and cost, while limiting the platform's ability to self-initiate recovery when individual domains are de-energized.

Networking and gateway functionality are often concentrated in a single compute domain. Such centralization can create bottlenecks for secure communication with external electronic control units and cloud backends, and it may expose internal resources beyond what is necessary for safety-critical operation. Additionally, fragmented telemetry collection across power, timing, and memory subsystems can hinder predictive maintenance and slow root-cause analysis.

Therefore, there is a need for an improved approach that overcomes at least the above-mentioned drawbacks.

### SUMMARY

Aspects of the present disclosure generally relate to the field of electronic computing systems and multi-die integrated circuit packaging for safety-critical and secure embedded applications. More particularly, the present disclosure relates to a chiplet-based integrated compute and smart power management system resulting in a smart integrated compute platform.

An aspect of the present disclosure pertains to a chiplet-based smart integrated compute system. The chiplet-based smart integrated compute system includes a safe compute subsystem configured to execute high-power compute operations and perform secure data exchange with external devices. The chiplet-based smart integrated compute system also includes a safe compute and safety monitoring subsystem configured to execute safety-critical operations and perform real-time safety monitoring independently of the safe compute subsystem. The chiplet-based smart integrated compute system also includes a plurality of dedicated secondary storage subsystems operatively coupled to the safe compute subsystem and the safe compute and safety monitoring subsystem, wherein each dedicated secondary storage subsystem is configured to provide volatile memory through a respective memory controller. The chiplet-based smart integrated compute system also includes a plurality of clock-generation subsystems configured to provide independent timing references to each subsystem. The chiplet-based smart integrated compute system also includes a plurality of power-regulation subsystems configured to provide independent regulated power to each subsystem.

The chiplet-based smart integrated compute system also includes a safe smart power management subsystem comprising one or more power-management integrated circuits and a microcontroller configured to perform intelligent power distribution to the safe compute subsystem, the safe compute and safety monitoring subsystem, and the plurality of dedicated secondary storage subsystems via respective power-regulation subsystems, and selectively isolate a faulty chiplet or a faulty power-regulation subsystem. Herein, each of the subsystems is interconnected by die-to-die interconnects within a unified package to provide high-speed communication, reduced latency, and freedom from interference among the subsystems.

In one embodiment, the safe compute and safety monitoring subsystem comprises a safety-rated compute core configured to continue executing the safety-critical operations when the safe compute subsystem is in a safe state.

In one embodiment, the microcontroller of the safe smart power management subsystem is further configured to manage power-on and reset sequences of the chiplet-based smart integrated compute system independently of any external microcontroller.

In one embodiment, the microcontroller is configured to perform firmware or software updates to the one or more power-management integrated circuits over-the-air through a secure network connection.

In one embodiment, each of the safe compute subsystem and the safe compute and safety monitoring subsystem comprises a dedicated secondary storage subsystem comprising volatile memory configured to store temporary operational data for the respective subsystem.

In one embodiment, each of the plurality of clock-generation subsystems comprises a crystal oscillator configured to provide a timing reference to a respective one of the safe compute subsystem, the safe compute and safety monitoring subsystem, or the plurality of dedicated secondary storage subsystems.

In one embodiment, each of the plurality of power-regulation subsystems comprises a pre-regulator configured to provide regulated voltage to a respective one of the safe compute subsystem, the safe compute and safety monitoring subsystem, or the plurality of dedicated secondary storage subsystems.

In one embodiment, the die-to-die interconnects comprise high-speed serial interfaces configured to facilitate secure data exchange among the plurality of subsystems integrated on a same substrate.

In one embodiment, the microcontroller is further configured to monitor thermal and electrical parameters of each of the subsystems across the chiplet-based smart integrated compute system and perform selective shutdown of at least one subsystem exhibiting a fault condition.

In one embodiment, the safe compute subsystem is configured to serve as a secure communication gateway for external electronic control units via a wireless communication network.

In one embodiment, the safe compute subsystem comprises a cryptographic processing unit configured to perform encryption and decryption of data exchanged between the chiplet-based smart integrated compute system and the external electronic control units, using hardware-embedded secure keys.

In one embodiment, the microcontroller is configured to transmit diagnostic telemetry data comprising health and performance data of the power-management integrated circuits and all the subsystems to a remote server for predictive maintenance.

Various objects, features, aspects, and advantages of the inventive subject matter will become more apparent from the following detailed description of preferred embodiments, along with the accompanying drawing figures in which like numerals represent like components.

### BRIEF DESCRIPTION OF THE DRAWINGS

The accompanying drawings, which are incorporated herein and form a part of the present disclosure, illustrate exemplary embodiments of the disclosed methods and systems. Like reference numerals refer to corresponding parts throughout the different drawings. The components depicted are not necessarily to scale; instead, emphasis is placed on clearly illustrating the principles of the present disclosure. Some drawings may represent components using block diagrams and may not depict the internal circuitry of each component. It will be appreciated by those skilled in the art that the disclosure of such drawings includes the implicit disclosure of electrical, electronic, or other circuitry commonly used to implement such components.

FIG. 1 illustrates an exemplary data-interaction environment including a chiplet-based computing system, in accordance with an embodiment of the present disclosure.

FIG. 2 illustrates an exemplary block diagram of a chiplet-based smart integrated safe compute platform, in accordance with an embodiment of the present disclosure.

FIG. 3A illustrates an example functional decomposition of resources that may be implemented within a chiplet-based smart integrated safe compute platform, in accordance with an embodiment of the present disclosure.

FIG. 3B illustrates an example functional decomposition of resources that may be utilized by a safe compute and safety monitoring subsystem within the chiplet-based smart integrated safe compute platform, in accordance with an embodiment of the present disclosure.

FIG. 4 illustrates an exemplary flow chart of a method for operating the chiplet-based smart integrated compute platform, in accordance with an embodiment of the present disclosure.

FIG. 5 illustrates an exemplary hardware environment, in accordance with an embodiment of the present disclosure.

The foregoing shall be more apparent from the following more detailed description of the disclosure.

### DETAILED DESCRIPTION

In the following description, various specific details are provided for the purpose of facilitating a thorough understanding of embodiments of the present disclosure; however, it will be understood that the embodiments may be practiced without such specific details. The features described herein may each be used independently or in combination with other features, and individual features may address only certain problems or aspects discussed, while some problems may not be entirely resolved by any one feature alone. The description of exemplary embodiments is intended solely to provide an enabling disclosure to those skilled in the art and is not intended to limit the scope, applicability, or configuration of the present disclosure. It will be appreciated that modifications to the function and arrangement of elements may be made without departing from the spirit or scope of the disclosure as defined by the appended claims.

The following is a detailed description of embodiments of the disclosure depicted in the accompanying drawings. The embodiments are in such detail as to clearly communicate the disclosure. If the specification states a component or feature “may”, “can”, “could”, or “might” be included or have a characteristic, that particular component or feature is not required to be included or have the characteristic.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

Existing embedded compute platforms for vehicles and similar safety-critical environments often centralize memory, timing, power, and gateway functions around a single compute domain. Shared memory paths, shared clocks, and shared power rails reduce freedom from interference and allow faults to propagate across domains. Board-level integration with long off-chip traces adds latency, increases power consumption, and complicates certification. Power-on and reset sequencing typically depends on external controllers, which limits deterministic bring-up and recovery. Gateway traffic concentrated in one domain creates security bottlenecks and exposes internal resources unnecessarily. Limited field servicing of power-management devices and fragmented telemetry hinder scalable performance tuning and predictive maintenance

The disclosure provides a chiplet-based smart integrated compute system that organizes functionality into a safe compute subsystem and a safe compute and safety monitoring subsystem with dedicated secondary storage subsystems, clock-generation subsystems, and power-regulation subsystems for each domain. Subsystems are interconnected by die-to-die interconnects within a unified package to provide high-speed communication with controlled pathways. A safe smart power management subsystem includes one or more power-management integrated circuits and a microcontroller that manages intelligent power distribution, local power-on and reset sequencing, over-the-air updates, and selective isolation of a faulty domain. The safe compute subsystem may operate as a secure communication gateway, and a cryptographic processing unit may protect exchanges with external electronic control units over a wireless link and with a cloud backend. Diagnostic telemetry aggregated across power, timing, memory, and interconnect health supports fleet-level analytics and policy updates.

Dedicated memory, clocks, and power per domain improve determinism, reduce interference, and confine faults to the affected subsystem. Die-to-die interconnects shorten data paths, lowering latency and power while preserving security through controlled access. Localized power-on and reset sequencing by the microcontroller enables autonomous recovery and higher system availability. Over-the-air updates to power-management integrated circuits and tunable power limits allow in-field scalability to meet workload and thermal constraints. Secure gateway operation with hardware-assisted cryptography strengthens the perimeter for external communications. Continuous telemetry and policy feedback enable predictive maintenance, faster root-cause analysis, and graceful degradation, resulting in a platform that is safer, more efficient, and easier to service.

The present disclosure aims to provide a chiplet-based smart integrated compute system that delivers high compute density with strong safety, security, and availability guarantees. A primary objective is to establish freedom from interference by allocating dedicated secondary storage subsystems, clock-generation subsystems, and power-regulation subsystems to each compute domain, enabling deterministic timing, predictable memory bandwidth, and domain-local power integrity. Another objective is to reduce latency and power while preserving controlled data paths by interconnecting subsystems through die-to-die interconnects within a unified package.

The disclosure further aims for continuous safety oversight through a safe compute and safety monitoring subsystem that maintains safety-critical operation independent of other domains. A safe smart power management subsystem with a microcontroller is intended to provide autonomous power-on and reset sequencing, selective isolation of faulty domains, and over-the-air updates to power-management integrated circuits, including tunable power limits for field scalability. Additional objectives include secure gateway communication with external electronic control units using a cryptographic processing unit, and lifecycle serviceability via diagnostic telemetry and predictive maintenance.

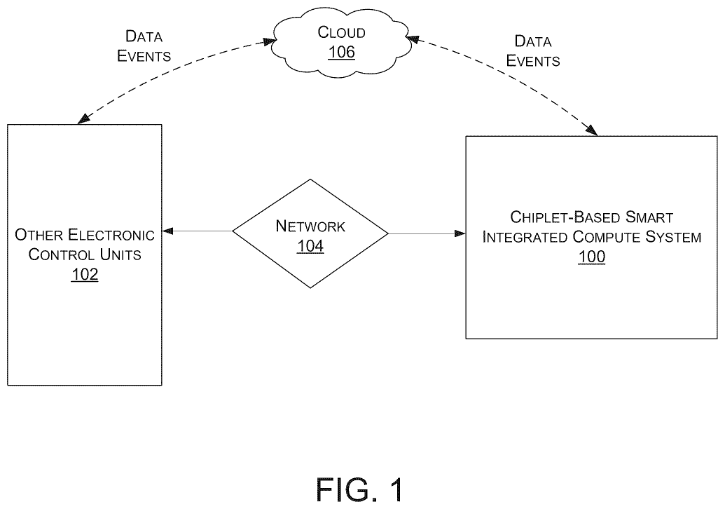

The various embodiments throughout the disclosure will be explained in more detail with reference to FIGS. 1-5.

FIG. 1 illustrates an exemplary data-interaction environment including a chiplet-based smart integrated compute system 100 communicatively coupled to other electronic control units 102 and to a cloud 106 via a network 104, in accordance with one or more embodiments of the present disclosure. As shown, data events may flow bidirectionally between the chiplet-based smart integrated compute system 100 and the cloud 106, and control or data messages may be exchanged between the chiplet-based smart integrated compute system 100 and the other electronic control units 102 through the network 104.

The network 104 may include in-vehicle and off-vehicle communication infrastructure that may support wired and/or wireless links to enable authenticated and reliable message exchange among the chiplet-based smart integrated compute system 100, the other electronic control units 102, and the cloud 106. The network 104 may further enable over-the-air provisioning and remote diagnostics consistent with vehicle cybersecurity practices, while maintaining real-time connectivity required by the associated applications. The wireless link of the network 104 may connect the chiplet-based smart integrated compute system 100 to the cloud 106, and may be secured in accordance with Wireless Fidelity Protected Access (WPA3) and International Organization for Standardization (ISO) 21434 cybersecurity practices.

The cloud 106 may include a remote or edge computing backend that may receive telemetry or operational data events from the chiplet-based smart integrated compute system 100 and may provide over-the-air firmware or software updates, configuration policies, or analytics feedback to the chiplet-based smart integrated compute system 100. In one example, the cloud 106 may aggregate data from multiple vehicles to assist with fleet-level monitoring and optimization.

The other electronic control units 102 may include domain controllers or function-specific controllers within a vehicle that may exchange messages with the chiplet-based smart integrated compute system 100 via the network 104. Such exchanges may include sensor data, actuation commands, status notifications, and configuration updates to enable coordinated operation within the vehicle electronic control environment.

In operation, and as represented in FIG. 1, the chiplet-based smart integrated compute system 100 may act as a communications node within a distributed ecosystem, continuously exchanging data events with the cloud 106 and interoperating with the other electronic control units 102 through the network 104 to support secure connectivity, remote servicing, and coordinated control.

In one embodiment, the other electronic control units 102 may include, by way of example, mobile phones, personal digital assistants (PDAs), aircraft control units, and vessel control units that may exchange authenticated messages with the chiplet-based smart integrated compute system 100 via the network 104.

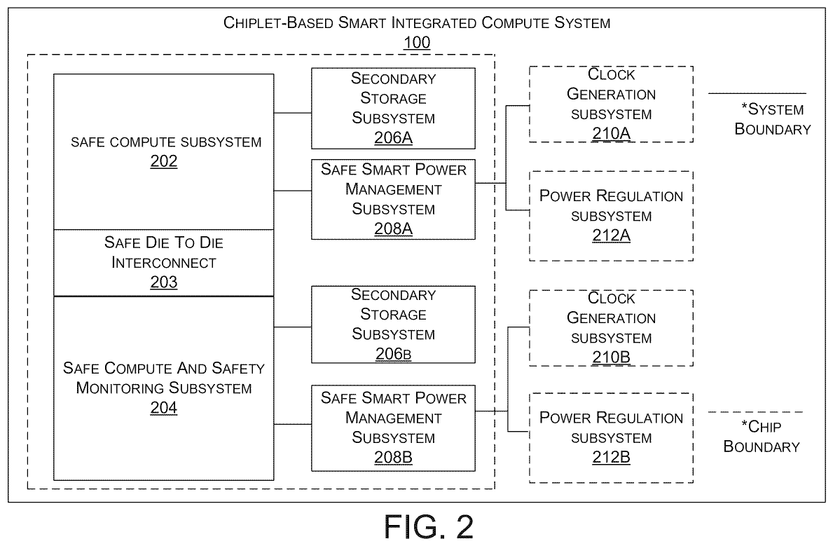

FIG. 2 illustrates an exemplary block diagram of the chiplet-based smart integrated compute system 100, in accordance with one or more embodiments of the present disclosure. The chiplet-based smart integrated compute system 100 is shown with a platform boundary and selected chip-level resources that may be located at a chip boundary. The arrangement depicts functional independence and dedicated resources for compute, safety monitoring, storage, timing, and power.

The chiplet-based smart integrated compute system 100 may include a safe compute subsystem 202 and a safe compute and safety monitoring subsystem 204. The safe compute subsystem 202 may execute high-power compute workloads. The safe compute and safety monitoring subsystem 204 may execute safety-critical workloads and continuous safety monitoring independently of the safe compute subsystem 202. A safe die-to-die interconnect 203 may provide high-speed, low-latency communication between the safe compute subsystem 202 and the safe compute and safety monitoring subsystem 204, while maintaining controlled data paths consistent with freedom-from-interference practices.

The chiplet-based smart integrated compute system 100 may include secondary storage subsystems 206A and 206B. Each secondary storage subsystem 206A and 206B may provide volatile memory through a respective memory controller dedicated to an associated compute domain. In one example, the secondary storage subsystem 206A may be associated with the safe compute subsystem 202, and the secondary storage subsystem 206B may be associated with the safe compute and safety monitoring subsystem 204. This arrangement may enable predictable memory bandwidth and isolation for safety-related execution.

The chiplet-based smart integrated compute system 100 may include safe smart power management subsystems 208A and 208B. Each safe smart power management subsystem 208A and 208B may include one or more power-management integrated circuits and a microcontroller, and may support intelligent power distribution, fault detection, and selective isolation of a faulty domain. In one example, the safe smart power management subsystem 208A may manage power distribution for resources associated with the safe compute subsystem 202, and the safe smart power management subsystem 208B may manage power distribution for resources associated with the safe compute and safety monitoring subsystem 204.

At the chip boundary, the chiplet-based smart integrated compute system 100 may include clock generation subsystems 210A and 210B and power regulation subsystems 212A and 212B. Each clock generation subsystem 210A and 210B may provide an independent timing reference for a corresponding compute domain, and each power regulation subsystem 212A and 212B may provide an independently regulated power rail for that domain. Locating these subsystems with clear association to their respective domains may enable deterministic timing behavior and power integrity, and may facilitate selective brownout handling and graceful degradation during localized faults.

In operation, FIG. 2 depicts a resource-partitioned arrangement in which the safe compute subsystem 202 and the safe compute and safety monitoring subsystem 204 may utilize their dedicated secondary storage subsystems 206A and 206B, may receive domain-specific power from the power regulation subsystems 212A and 212B under the control of the safe smart power management subsystems 208A and 208B, and may operate on independent timing references provided by the clock generation subsystems 210A and 210B. The safe die-to-die interconnect 203 may enable coordinated data exchange between the compute domains while preserving domain isolation.

In one embodiment, the safe compute and safety monitoring subsystem 204 may coordinate auxiliary-power policies with the safe smart power management subsystems 208A, 208B, including requesting and supervising auxiliary power delivery to selected domains via the power-regulation subsystems 212A, 212B.

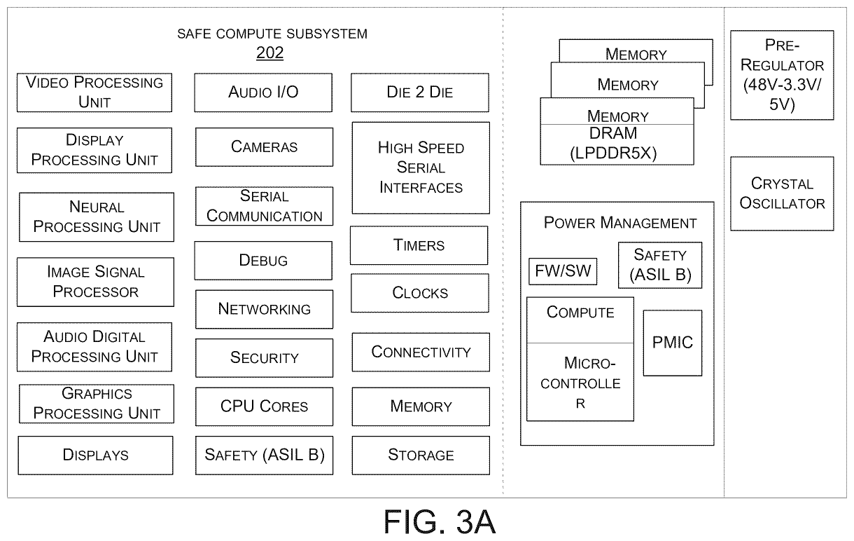

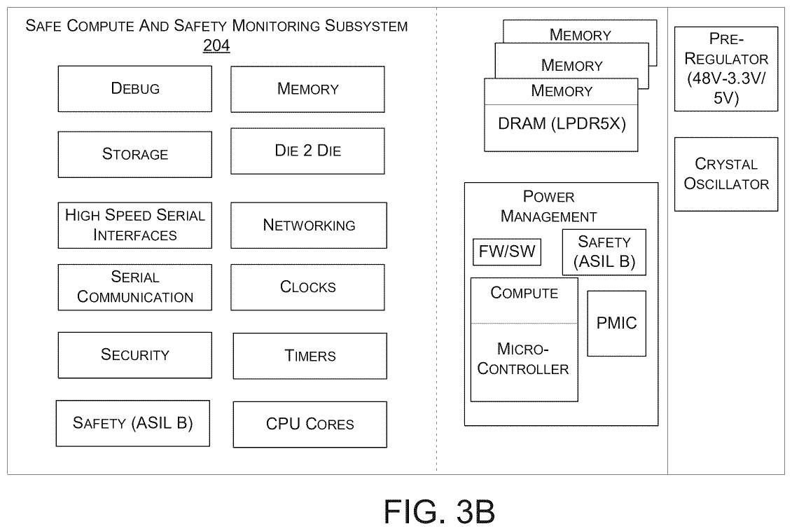

FIG. 3A illustrates an example functional decomposition of resources that may be implemented within the chiplet-based smart integrated compute system 100, in accordance with one or more embodiments of the present disclosure. The depiction is organized to show application and media processing blocks, input/output and infrastructure blocks, high-speed interconnect resources, memory devices, and platform-level timing and power resources. The arrangement is representative and may be tailored to a target vehicle program while remaining within the scope of the chiplet architecture described for the chiplet-based smart integrated compute system 100.

The left group depicts application and media processing resources that a safe compute subsystem 202 may include, such as a video processing unit, a display processing unit, a neural processing unit, an image signal processor, an audio digital processing unit, a graphics processing unit, and one or more display interfaces, but not limited thereto. In one embodiment, an automotive Safety Integrity Level (ASIL-B) function shown in FIG. 3A may represent safety-related monitors or supervisors associated with application pipelines, and may operate under policies issued by a safe compute and safety monitoring subsystem 204.

The center group depicts input/output and infrastructure resources that the chiplet-based smart integrated compute system 100 may include, such as audio input/output interfaces, camera interfaces, serial communication interfaces, debug interfaces, networking interfaces, security engines, and central processing unit cores, but not limited thereto. Also shown are interconnect and timing elements, including a die-to-die interface and a high-speed serial interface that may be realized by a safe die-to-die interconnect 203, as well as timers and clocks that may provide deterministic scheduling for workload execution. Connectivity, memory controllers, and storage controllers are further indicated to emphasize that the safe compute subsystem 202 and the safe compute and safety monitoring subsystem 204 may utilize dedicated data paths and resources consistent with freedom-from-interference practices. The safety (ASIL-B) function illustrated in this group may represent domain-specific safety logic that coordinates with the safe compute and safety monitoring subsystem 204.

The right group depicts memory devices and power and timing resources associated with platform-level operation. Multiple memory devices, including dynamic random-access memory such as, low-power double data rate 5X (LPDDR5X), are shown to indicate that secondary storage subsystems 206A and 206B may be populated with technology-appropriate volatile memory under the control of respective memory controllers. A power-management integrated circuit block is illustrated with firmware or software logic, a compute block, and a microcontroller, indicating that a safe smart power management subsystem 208A or 208B may implement intelligent power distribution, monitoring, and selective isolation policies for associated domains.

Also shown are a pre-regulator and a crystal oscillator, which exemplify resources that clock generation subsystems 210A and 210B and power regulation subsystems 212A and 212B may include. The pre-regulator may condition input supply rails for downstream regulation stages serving the compute domains, and the crystal oscillator may provide a stable timing reference for time-base generation, clock supervision, and startup sequencing. Placement and association of these resources may be selected to maintain predictable timing behavior and power integrity for each domain.

In operation, the elements depicted in FIG. 3A illustrate how the chiplet-based smart integrated compute system 100 may assemble heterogeneous processing engines with dedicated connectivity, memory, timing, and power resources. The safe die-to-die interconnect 203 and the high-speed serial interface may enable low-latency data movement between chiplets while preserving domain isolation, the secondary storage subsystems 206A and 206B may sustain deterministic memory bandwidth for their respective domains, and the safe smart power management subsystems 208A and 208B, together with the power regulation subsystems 212A and 212B and the clock generation subsystems 210A and 210B, may enforce safe startup, runtime supervision, and graceful degradation, in accordance with one or more embodiments of the present disclosure.

The safe smart power management subsystem 208A, 208B may include a wireless fidelity (Wi-Fi)-enabled microcontroller configured to receive OTA updates that adjust power management integrated circuit (PMIC) power-limit settings for workload scalability across associated domains. The microcontroller of the safe smart power management subsystem 208A, 208B may be powered from a pre-regulator within the power-regulation subsystems 212A, 212B, independent of domain PMIC rails, enabling self-triggered power-on and reset sequencing when other rails are de-energized.

In one embodiment, the infrastructure interfaces may include a Joint Test Action Group (JTAG) interface for board-level debug and boundary scan, alongside storage and Ethernet/PCIe links used by the chiplet-based smart integrated compute system 100.

FIG. 3B illustrates an example functional decomposition of resources that may be utilized by a safe compute and safety monitoring subsystem 204 within the chiplet-based smart integrated compute system 100, in accordance with one or more embodiments of the present disclosure. The depiction groups elements to show processing and safety logic, input/output and infrastructure interfaces, interconnect resources, memory devices, and platform-level timing and power resources associated with the safe compute and safety monitoring subsystem 204.

The left group depicts processing and supervision resources that the safe compute and safety monitoring subsystem 204 may include, such as central processing unit cores, security engines, a safety (ASIL-B) function, storage controllers, serial communication interfaces, high-speed input/output, and debug interfaces. These resources may enable execution of safety-critical software, implementation of safety monitors, enforcement of security policies, and capture of diagnostic context for post-event analysis.

The centre group depicts infrastructure interfaces that the chiplet-based smart integrated compute system 100 may include to support the safe compute and safety monitoring subsystem 204, such as memory controllers, a die-to-die interface that may be realized by a safe die-to-die interconnect 203, networking interfaces, clocks, and timers, but not limited thereto. The die-to-die interface may provide a controlled data path for deterministic, low-latency exchange between chiplets, while the clocks and timers may provide time bases for scheduling, watchdogs, and time-synchronization functions associated with safety supervision.

The right group depicts memory devices and power and timing resources associated with platform-level operation. Multiple memory devices, including dynamic random-access memory such as LPDDR5X, are shown to indicate that one or more secondary storage subsystems 206A and 206B may be populated with technology-appropriate volatile memory for the safe compute and safety monitoring subsystem 204 under respective memory controllers. A power-management integrated circuit block is illustrated with firmware or software logic, a compute function, and a microcontroller, indicating that a safe smart power management subsystem 208A or 208B may implement power distribution, monitoring, and selective isolation policies for the domain associated with the safe compute and safety monitoring subsystem 204.

Also shown are a pre-regulator and a crystal oscillator, which exemplify resources that power regulation subsystems 212A and 212B and clock generation subsystems 210A and 210B may include. The pre-regulator may condition an input supply for downstream regulation stages serving the safety domain, and the crystal oscillator may provide a stable timing reference for clock generation, startup sequencing, and clock supervision. In operation, the elements depicted in FIG. 3B illustrate how the safe compute and safety monitoring subsystem 204 may utilize dedicated connectivity, memory, timing, and power resources, coordinated over the safe die-to-die interconnect 203, within the chiplet-based smart integrated compute system 100.

The safe smart power management subsystem 208A, 208B may include a wireless fidelity (Wi-Fi)-enabled microcontroller that may apply over-the-air (OTA)-delivered policies to tune power management integrated circuit (PMIC) power-limit parameters for the domain of the safe compute and safety monitoring subsystem 204 to support scalable operation. Further, in one embodiment, the safe smart power management subsystem 208A, 208B may include a microcontroller that may monitor selected external devices, including package thermistors and external storage devices, and may coordinate with the safe compute and safety monitoring subsystem 204 to apply safety actions for the chiplet-based smart integrated compute system 100.

The microcontroller of the safe smart power management subsystem 208A, 208B may receive power from a pre-regulator of the power-regulation subsystems 212A, 212B, allowing autonomous bring-up and reset control for the safety domain even if unrelated PMIC rails are unavailable. At the chip boundary, a pre-regulator of the power-regulation subsystems 212A, 212B may supply the microcontroller of the safe smart power management subsystem 208A, 208B so that power-on and reset actions may be initiated locally without reliance on energized domain rails.

In one embodiment, the chiplet-based smart integrated compute system 100 may include the safe compute subsystem 202 configured to execute high-power compute operations and to perform secure data exchange with external devices. The safe compute subsystem 202 may host application workloads that require substantial processing throughput, and may expose controlled interfaces for exchanging data with other electronic control units or back-end services while adhering to security policies of the chiplet-based smart integrated compute system 100.

The chiplet-based smart integrated compute system 100 may further include the safe compute and safety monitoring subsystem 204 configured to execute safety-critical operations and to perform real-time safety monitoring independently of the safe compute subsystem 202. The safe compute and safety monitoring subsystem 204 may implement supervision logic, watchdogs, and health checks that operate without reliance on scheduling or memory resources allocated to the safe compute subsystem 202, thereby maintaining operational independence suitable for safety functions.

The plurality of dedicated secondary storage subsystems 206A, 206B may be operatively coupled to the safe compute subsystem 202 and to the safe compute and safety monitoring subsystem 204. Each dedicated secondary storage subsystem 206A, 206B may provide volatile memory through a respective memory controller, enabling deterministic bandwidth allocation and predictable latency for the associated compute domain. This arrangement may facilitate freedom from interference between the safe compute subsystem 202 and the safe compute and safety monitoring subsystem 204 at the memory level.

The chiplet-based smart integrated compute system 100 may include the plurality of clock-generation subsystems 210A, 210B configured to provide independent timing references to each subsystem. Independent timing sources may allow each compute domain to maintain its own clocking profile, which may support domain isolation and predictable real-time behavior. The chiplet-based smart integrated compute system 100 may also include the plurality of power-regulation subsystems 212A, 212B configured to provide independently regulated power to each subsystem, thereby enabling domain-specific voltage and current limits and facilitating localized power fault handling.

The safe smart power management subsystem 208A, 208B may include one or more power-management integrated circuits and a microcontroller. The safe smart power management subsystem 208A, 208B may be configured to perform intelligent power distribution to the safe compute subsystem 202, to the safe compute and safety monitoring subsystem 204, and to the plurality of dedicated secondary storage subsystems 206A, 206B via the respective power-regulation subsystems 212A, 212B. The safe smart power management subsystem 208A, 208B may selectively isolate a faulty chiplet or a faulty power-regulation subsystem to preserve operation of non-faulty domains and to support graceful degradation.

Each of the subsystems described above may be interconnected by die-to-die interconnects 203 within a unified package. The die-to-die interconnects 203 may provide high-speed communication and reduced latency among the subsystems while maintaining controlled data paths and resource partitioning, thereby supporting freedom from interference among the subsystems in the chiplet-based smart integrated compute system 100. In one embodiment, the safe compute and safety monitoring subsystem 204 may optionally operate as a secure communication gateway for safety-relevant exchanges with external electronic control units 102 via the network 104, while enforcing access-control policies over the die-to-die interconnects 203.

In one embodiment, the timing resources associated with the safe compute and safety monitoring subsystem 204 may optionally include a low-noise baseband (LNBB) clock to enhance jitter-sensitive supervision functions, and a low-power sleep clock to sustain safety monitoring during low-power modes.

In one embodiment, the infrastructure interfaces associated with the safe compute and safety monitoring subsystem 204 may include a Joint Test Action Group (JTAG) interface to enable non-intrusive debug and safety validation while preserving freedom from interference across domains.

In one embodiment, the safe compute and safety monitoring subsystem 204 may collaborate with the safe smart power management subsystems 208A, 208B to provide auxiliary power to designated resources through the power-regulation subsystems 212A, 212B to sustain safety-critical functions during constrained operating states.

In one embodiment, the safe compute and safety monitoring subsystem 204 may include a safety-rated compute core that is configured to continue executing safety-critical operations when the safe compute subsystem 202 enters a safe state. The safe state of the safe compute subsystem 202 may correspond to a reset, a quiescent hold, or a controlled shutdown invoked in response to a detected fault or an update event. While the safe compute subsystem 202 remains in the safe state, the safety-rated compute core within the safe compute and safety monitoring subsystem 204 may maintain supervision functions, may service safety-relevant control loops, and may issue status notifications over controlled interfaces.

To support uninterrupted execution, the safety-rated compute core of the safe compute and safety monitoring subsystem 204 may utilize an independent timing reference provided by a clock-generation subsystem 210B, regulated power provided by a power-regulation subsystem 212B, and volatile memory provided by a dedicated secondary storage subsystem 206B. Communication with other subsystems may occur through the die-to-die interconnects 203 using policies that preserve freedom from interference while allowing the safety-rated compute core to coordinate with external devices as needed to maintain vehicle safety.

In one embodiment, a microcontroller within the safe smart power management subsystem 208A, 208B may be configured to manage power-on and reset sequences of the chiplet-based smart integrated compute system 100 independently of any external microcontroller. The microcontroller of the safe smart power management subsystem 208A, 208B may orchestrate domain bring-up by enabling pre-power checks, commanding the respective power-regulation subsystems 212A, 212B through staged rail activation, verifying rail stability, and releasing resets to the safe compute subsystem 202, the safe compute and safety monitoring subsystem 204, and the dedicated secondary storage subsystems 206A, 206B in a prescribed order. During reset events, the microcontroller of the safe smart power management subsystem 208A, 208B may assert and de-assert local and inter-chiplet resets over the die-to-die interconnects 203, may gate or ungate timing sources provided by the clock-generation subsystems 210A, 210B, and may apply retry and fallback policies to place a faulty domain in a safe state while allowing non-faulty domains to resume operation. This local control may allow power-on initialization and subsequent resets to be executed without reliance on any external microcontroller, thereby improving determinism and availability of the chiplet-based smart integrated compute system 100.

In one embodiment, a microcontroller within the safe smart power management subsystem 208A, 208B may be configured to perform firmware or software updates to the one or more power-management integrated circuits over-the-air through a secure network connection. The microcontroller of the safe smart power management subsystem 208A, 208B may establish an authenticated session over the network 104 to a trusted update service hosted on the cloud 106, may download a signed update package, and may stage the package in update memory associated with the chiplet-based smart integrated compute system 100.

The microcontroller of the safe smart power management subsystem 208A, 208B may verify the authenticity and integrity of the staged package, may check version and compatibility information, and may schedule an update window that places affected domains in a safe state while maintaining operation of safety-critical functions executed by the safe compute and safety monitoring subsystem 204. During the update, the microcontroller of the safe smart power management subsystem 208A, 208B may transfer the validated image to the target power-management integrated circuit over an internal control interface, may monitor programming status and power health via the respective power-regulation subsystems 212A, 212B, and may confirm successful activation of the new firmware or software.

In one embodiment, the safe compute subsystem 202 and the safe compute and safety monitoring subsystem 204 may each include a dedicated secondary storage subsystem 206A, 206B that provides volatile memory configured to store temporary operational data for the respective subsystem. The dedicated secondary storage subsystem 206A may be associated with the safe compute subsystem 202 and may buffer high-throughput application data, intermediate results, and runtime state required for high-power compute operations. The dedicated secondary storage subsystem 206B may be associated with the safe compute and safety monitoring subsystem 204 and may retain safety-relevant context, diagnostic records, and scheduling data used by supervision tasks and safety-critical control loops.

Each dedicated secondary storage subsystem 206A, 206B may include a respective memory controller that may enforce deterministic bandwidth allocation, quality-of-service policies, and error-correction features suitable for the associated compute domain. By providing volatile memory that is electrically and logically isolated per domain, the chiplet-based smart integrated compute system 100 may maintain predictable latency for memory transactions, may reduce contention between domains, and may preserve freedom from interference while the safe compute subsystem 202 and the safe compute and safety monitoring subsystem 204 execute their respective workloads. In some examples, the volatile memory of the dedicated secondary storage subsystems 206A, 206B may be implemented using technology-appropriate dynamic random-access memory, and may be configured for periodic integrity checks and controlled retention policies consistent with domain requirements.

In one embodiment, each clock-generation subsystem 210A, 210B may include a crystal oscillator configured to provide a timing reference to a respective one of the safe compute subsystem 202, the safe compute and safety monitoring subsystem 204, or the dedicated secondary storage subsystems 206A, 206B. The crystal oscillator of each clock-generation subsystem 210A, 210B may establish an independent and stable time base that may be used to derive local clocks for processing pipelines, communication interfaces, and memory transactions associated with the corresponding domain. Providing a crystal-oscillator timing reference per domain may enable deterministic scheduling, may reduce cross-domain clock coupling, and may support freedom from interference by preventing timing faults in one domain from propagating to another domain.

In some examples, the clock-generation subsystems 210A, 210B may distribute the crystal-oscillator timing reference to local clock trees for the associated domain, may support startup sequencing coordinated with the safe smart power management subsystem 208A, 208B, and may expose clock-good indicators that allow the microcontroller of the safe smart power management subsystem 208A, 208B to gate resets only after timing stability is achieved. For memory-centered domains, the crystal-oscillator timing reference may be used to meet setup and hold requirements of the dedicated secondary storage subsystems 206A, 206B, and for compute-centered domains, the crystal-oscillator timing reference may be used to maintain jitter performance for high-speed serial interfaces carried over the die-to-die interconnects 203. This arrangement may improve clock integrity within each domain while preserving the independence of timing behavior across domains in the chiplet-based smart integrated compute system 100.

In one embodiment, each power-regulation subsystem 212A, 212B may include a pre-regulator configured to provide regulated voltage to a respective one of the safe compute subsystem 202, the safe compute and safety monitoring subsystem 204, or the dedicated secondary storage subsystems 206A, 206B. The pre-regulator of each power-regulation subsystem 212A, 212B may condition an input supply, may stabilize line and load transients, and may establish a domain-specific voltage level that downstream regulation stages for the associated domain may further refine as required by local processing and memory timing constraints.

The pre-regulator within each power-regulation subsystem 212A, 212B may support soft-start, current limiting, and over-voltage and under-voltage protection policies coordinated by a microcontroller of the safe smart power management subsystem 208A, 208B. During power-on or reset sequencing, the microcontroller of the safe smart power management subsystem 208A, 208B may instruct the pre-regulator of the target domain to ramp to a specified voltage profile, may verify stability via health indicators, and may then release domain resets in coordination with clock-generation subsystems 210A, 210B. In operation, domain-local pre-regulation may improve power integrity, may reduce cross-domain coupling, and may facilitate selective isolation of a faulty domain while maintaining operation of non-faulty domains within the chiplet-based smart integrated compute system 100.

In one embodiment, the die-to-die interconnects 203 may include high-speed serial interfaces configured to facilitate secure data exchange among the safe compute subsystem 202, the safe compute and safety monitoring subsystem 204, the dedicated secondary storage subsystems 206A, 206B, the clock-generation subsystems 210A, 210B, and the power-regulation subsystems 212A, 212B integrated on the same substrate within a unified package. The high-speed serial interfaces of the die-to-die interconnects 203 may provide low-latency, high-throughput links with lane-level flow control and error detection suitable for deterministic transfers between domains while maintaining freedom from interference.

In one exemplary embodiment, the high-speed serial interfaces of the die-to-die interconnects 203 may support authenticated link initialization, traffic isolation through virtual channels or access-control policies, and payload protection using encryption features implemented within the respective subsystems. The die-to-die interconnects 203 may further allow the microcontroller of the safe smart power management subsystem 208A, 208B to exchange control and health-status messages with the target domains during power-on, runtime supervision, and selective isolation events, thereby enabling secure and coordinated operation of the chiplet-based smart integrated compute system 100.

In one embodiment, a microcontroller of the safe smart power management subsystem 208A, 208B may be configured to monitor thermal and electrical parameters of each subsystem across the chiplet-based smart integrated compute system 100 and to perform selective shutdown of at least one subsystem exhibiting a fault condition. The microcontroller of the safe smart power management subsystem 208A, 208B may obtain measurements and health indicators exposed by the power-regulation subsystems 212A, 212B and by on-domain monitors, may evaluate the measurements against policy thresholds, and may determine whether a thermal excursion, an over-current event, an under-voltage event, or an instability condition exists for a target domain.

Upon detection of a fault condition, the microcontroller of the safe smart power management subsystem 208A, 208B may initiate a controlled shutdown sequence for the affected subsystem by commanding the associated power-regulation subsystem 212A or 212B to remove or reduce power according to a predefined profile, while maintaining operation of non-faulty domains. Coordination messages may be issued over the die-to-die interconnects 203 to hold or flush in-flight transactions and to notify the safe compute and safety monitoring subsystem 204 so that safety-critical operations may continue. Diagnostic context related to the event may be stored using the dedicated secondary storage subsystem 206A or 206B associated with the relevant domain, and, after stabilization, the microcontroller of the safe smart power management subsystem 208A, 208B may attempt recovery actions consistent with system policy, thereby preserving freedom from interference and supporting graceful degradation within the chiplet-based smart integrated compute system 100.

In one embodiment, the safe compute subsystem 202 may be configured to serve as a secure communication gateway for external electronic control units 102 via a wireless communication network 104. The safe compute subsystem 202 may terminate wireless protocols, may authenticate peer devices, and may route authorized traffic to internal domains over die-to-die interconnects 203 while enforcing access-control policies that preserve freedom from interference with the safe compute and safety monitoring subsystem 204.

The safe compute subsystem 202 may include gateway functions such as packet filtering, intrusion detection, protocol translation, and application-layer firewalls, and may apply cryptographic services for confidentiality, integrity, and replay protection during exchanges with the external electronic control units 102. In some examples, the safe compute subsystem 202 may manage key material and certificates for the secure communication gateway function, may monitor link quality and session state for the wireless communication network 104, and may maintain quality-of-service policies that prioritize safety-relevant messages without exposing internal resources beyond authorized interfaces.

During operation, the safe compute subsystem 202 may broker secure data exchange between the external electronic control units 102 and internal subsystems, may stage payloads in a dedicated secondary storage subsystem 206A, and may coordinate with the safe smart power management subsystem 208A, 208B for link-aware power policies. The arrangement may allow over-the-air interactions and vehicle-to-cloud or vehicle-to-vehicle exchanges to occur through the safe compute subsystem 202 as a secure communication gateway while the safe compute and safety monitoring subsystem 204 continues independent safety-critical execution.

In one embodiment, the safe compute subsystem 202 may include a cryptographic processing unit configured to perform encryption and decryption of data exchanged between the chiplet-based smart integrated compute system 100 and the external electronic control units 102 over the wireless communication network 104. The cryptographic processing unit may utilize hardware-embedded secure keys to establish authenticated sessions, to protect payload confidentiality and integrity, and to provide replay protection for gateway traffic handled by the safe compute subsystem 202.

In one exemplary embodiment, the cryptographic processing unit of the safe compute subsystem 202 may expose accelerated primitives for symmetric and asymmetric cryptography, may support secure key derivation and key wrapping using hardware-embedded secure keys, and may verify digital signatures on control messages directed to internal domains over the die-to-die interconnects 203. Session metadata or transient cryptographic state may be staged in a dedicated secondary storage subsystem 206A under access controls that preserve freedom from interference with the safe compute and safety monitoring subsystem 204. This arrangement may enable the safe compute subsystem 202 to operate as a secure communication gateway while maintaining isolation and deterministic behavior across the chiplet-based smart integrated compute system 100.

In one embodiment, the microcontroller of the safe smart power management subsystem 208A, 208B may be configured to transmit diagnostic telemetry data, including health and performance data of the power-management integrated circuits and all subsystems of the chiplet-based smart integrated compute system 100, to a remote server on the cloud 106 for predictive maintenance via the network 104. The diagnostic telemetry data may include one or more of rail voltages, currents, temperatures, fault flags, error counters, clock-good indications from the clock-generation subsystems 210A, 210B, reset counts, power-up timing margins, memory integrity statistics from the dedicated secondary storage subsystems 206A, 206B, and link health metrics for the die-to-die interconnects 203.

The microcontroller may gather local measurements and may poll status registers exposed by the power-regulation subsystems 212A, 212B and by monitored endpoints in the safe compute subsystem 202 and the safe compute and safety monitoring subsystem 204. The microcontroller of the safe smart power management subsystem 208A, 208B may timestamp and organize the diagnostic telemetry data into authenticated payloads, may coordinate with the safe compute subsystem 202 for cryptographic services when required by policy, and may upload the payloads to the cloud 106 at periodic intervals or upon event triggers such as threshold crossings.

In operation, the remote server on the cloud 106 may analyze the diagnostic telemetry data to infer degradation trends, to predict remaining useful life for selected components, and to return maintenance advisories. In response, the microcontroller of the safe smart power management subsystem 208A, 208B may adjust local thresholds, may refine power or thermal derating policies, and may schedule further health checks, thereby enabling data-driven predictive maintenance while preserving freedom from interference across domains within the chiplet-based smart integrated compute system 100.

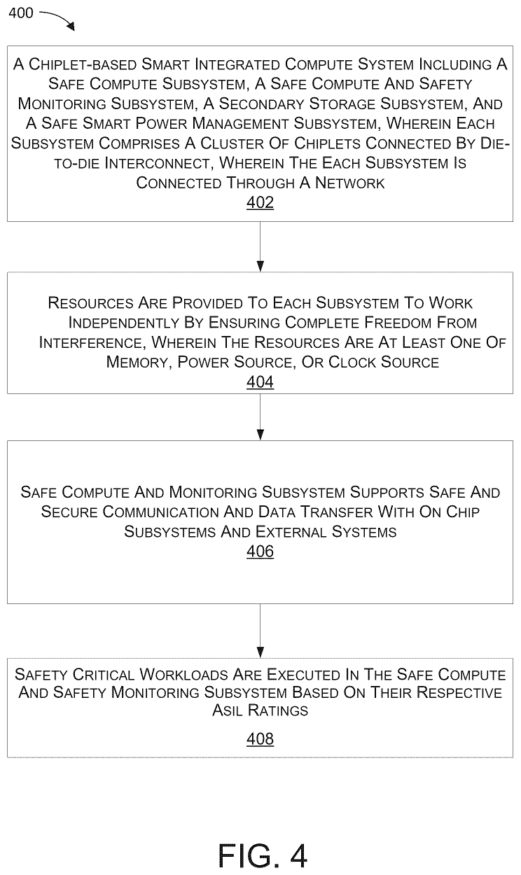

Referring now to FIG. 4, an exemplary flow chart of a method 400 for operating the chiplet-based smart integrated compute system 100 is illustrated, in accordance with one or more embodiments of the present disclosure. In one embodiment, the method 400 may be implemented by the chiplet-based smart integrated compute system 100 that includes the safe compute subsystem 202, the safe compute and safety monitoring subsystem 204, dedicated secondary storage subsystems 206A, 206B, clock-generation subsystems 210A, 210B, power-regulation subsystems 212A, 212B, die-to-die interconnects 203, and the safe smart power management subsystem 208A, 208B.

At step 402, the method 400 may include initializing the chiplet-based smart integrated compute system 100 that includes the safe compute subsystem 202, the safe compute and safety monitoring subsystem 204, at least one secondary storage subsystem, and the safe smart power management subsystem, where the subsystems are connected by die-to-die interconnects 203 and the chiplet-based smart integrated compute system 100 is connected to external systems through the network 104. The initialization may establish authenticated links, may enumerate subsystems, and may prepare the chiplet-based smart integrated compute system 100 for coordinated operation.

At step 404, the method 400 may include providing resources to each subsystem to operate independently with freedom from interference, wherein the resources include at least one of memory, power source, or clock source. In one example, dedicated secondary storage subsystems 206A, 206B may supply volatile memory through respective memory controllers, power-regulation subsystems 212A, 212B may supply regulated voltage, and clock-generation subsystems 210A, 210B may supply independent timing references.

At step 406, the method 400 may include enabling the safe compute and safety monitoring subsystem 204 to support safe and secure communication and data transfer with on-chip subsystems over the die-to-die interconnects 203 and with external systems over the network 104. Policies enforced at this step may include authentication, access control, and message integrity suited for coordinated operation of the chiplet-based smart integrated compute system 100.

At step 408, the method 400 may include executing safety-critical workloads in the safe compute and safety monitoring subsystem 204 based on applicable Automotive Safety Integrity Level ratings. Execution at this step may continue even when the safe compute subsystem 202 is placed in a safe state, thereby maintaining supervision and safety functions while preserving independence across domains of the chiplet-based smart integrated compute system 100.

It should be appreciated that the steps of the method 400 described herein are not limited to the specific sequence or structure outlined above. The method 400 may be implemented in various other ways, and the steps may be reordered, combined, omitted, or modified without departing from the scope or spirit of the present disclosure. The examples provided are for illustrative purposes only and are not intended to limit the present disclosure to the specific embodiments described. Those skilled in the art will recognize that various modifications and adaptations may be made to the method 400 based on implementation-specific requirements.

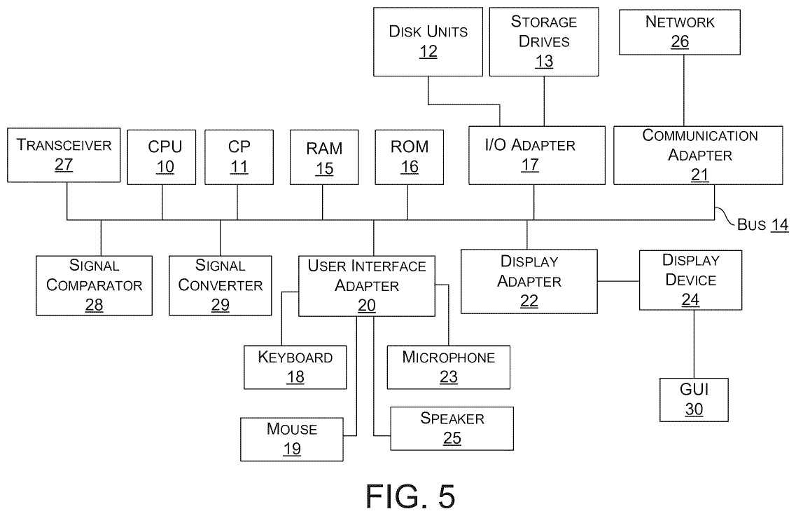

Referring now to FIG. 5, an exemplary hardware environment 500 is illustrated for practicing the techniques described with reference to FIGS. 1 through 4, in accordance with one or more embodiments of the present disclosure. The hardware environment 500 may be used to implement one or more roles in the system context, including a cloud 106 backend, a development or provisioning workstation, or an external electronic control unit 102 interfacing with the chiplet-based smart integrated compute system 100.

The hardware environment 500 may include a central processing unit (CPU) 10 and a coprocessor (CP) 11 coupled over a bus 14. The CPU 10 and the CP 11 may execute control logic, analytics, provisioning workflows, or gateway applications that coordinate with the chiplet-based smart integrated compute system 100. Volatile memory may be provided by random-access memory (RAM) 15, and non-volatile program memory may be provided by read-only memory (ROM) 16.

Persistent storage resources may include disk units 12 and storage drives 13 that may store operating systems, firmware images, configuration policies, diagnostic telemetry archives, and application binaries. An input/output (I/O) adapter 17 may interface the disk units 12 and the storage drives 13 to the bus 14 for block-level access.

User interaction may be supported through a user interface adapter 20 coupled to one or more input peripherals such as a keyboard 18 and a mouse 19. Audio input and output may be supported by a microphone 23 and a speaker 25. A display adapter 22 may drive a display device 24 that may present a graphical user interface (GUI) 30 for activities such as secure onboarding of the chiplet-based smart integrated compute system 100, inspection of diagnostic telemetry, or orchestration of over-the-air updates.

Network connectivity may be provided by a communications adapter 21 and, in wireless scenarios, by a transceiver 27. The communications adapter 21 and the transceiver 27 may enable secure data exchange with the network 26 to reach the cloud 106 or to interface with external electronic control units 102, consistent with the interactions described for FIG. 1. In some examples, the communications adapter 21 may support authenticated sessions used to deliver signed firmware or software images to a safe smart power management subsystem 208A, 208B.

Hardware-assisted signal handling may be supported by a signal comparator 28 and a signal converter 29 coupled to the bus 14. The signal comparator 28 may be used for thresholding or event detection during hardware-in-the-loop testing, and the signal converter 29 may convert between analog and digital domains for measurement or stimulation tasks related to validation of the chiplet-based smart integrated compute system 100.

In operation, the hardware environment 500 of FIG. 5 may execute applications that establish secure sessions to the cloud 106, may store and stage update packages on the storage drives 13, may visualize system status through the GUI 30, and may log or analyze telemetry received from the chiplet-based smart integrated compute system 100. The arrangement shown in FIG. 5 is illustrative of a general-purpose computing platform that may be configured to support deployment, monitoring, and servicing workflows associated with the methods and system interactions described in FIGS. 1 through 4, in accordance with one or more embodiments of the present disclosure.

The present disclosure may be applied across multiple domains that benefit from high-performance compute with safety, security, and availability requirements. In automotive electronics, the chiplet-based smart integrated compute system 100 may operate as a central vehicle controller or a domain controller that may execute perception, infotainment, and secure gateway workloads in the safe compute subsystem 202, while the safe compute and safety monitoring subsystem 204 may maintain safety-critical supervision. In industrial automation and robotics, the chiplet-based smart integrated compute system 100 may host motion-planning and machine-vision pipelines with real-time interlocks and over-the-air servicing coordinated through the safe smart power management subsystems 208A, 208B.

In aerospace and defense avionics, the chiplet-based smart integrated compute system 100 may enable partitioned mission computing with deterministic timing supported by clock-generation subsystems 210A, 210B and fault containment enforced over die-to-die interconnects 203. In marine and rail systems, the chiplet-based smart integrated compute system 100 may provide a secure communication gateway to external electronic control units 102 via the network 104, and may apply coordinated power policies using power-regulation subsystems 212A, 212B to sustain long-duty missions. In healthcare and smart-infrastructure edge nodes, the chiplet-based smart integrated compute system 100 may ensure secure data handling and audited updates, while dedicated secondary storage subsystems 206A, 206B may support predictable memory bandwidth for analytics and monitoring tasks. Across these domains, the die-to-die interconnects 203, the dedicated secondary storage subsystems 206A, 206B, the clock-generation subsystems 210A, 210B, the power-regulation subsystems 212A, 212B, and the safe smart power management subsystems 208A, 208B may collectively enable scalable compute density, freedom from interference, and graceful degradation under fault conditions.

The chiplet-based smart integrated compute system 100 may reduce latency and power by placing the safe compute subsystem 202, the safe compute and safety monitoring subsystem 204, and the die-to-die interconnects 203 within a unified package, thereby shortening data paths and limiting off-package traffic. Dedicated secondary storage subsystems 206A, 206B, clock-generation subsystems 210A, 210B, and power-regulation subsystems 212A, 212B may establish freedom from interference, enabling deterministic timing, predictable memory bandwidth, and domain-local power integrity. Such partitioned resource model may simplify safety analysis and certification by clearly delineating functional boundaries.

The safe smart power management subsystems 208A, 208B may enhance availability through autonomous power-on and reset sequencing, selective isolation of faulty domains, and policy-driven recovery without reliance on external controllers. Over-the-air servicing of power-management integrated circuits, coordinated by a microcontroller within the safe smart power management subsystems 208A, 208B, may enable field tuning of power limits for workload scalability and thermal constraints. The safe compute subsystem 202 may serve as a secure communication gateway to external electronic control units 102 via a wireless link on a network 104, while a cryptographic processing unit may protect data in transit. Continuous diagnostic telemetry to a cloud 106 may support predictive maintenance and faster root-cause analysis. Collectively, these capabilities may yield improved performance per watt, higher system availability, enhanced security posture, and graceful degradation under localized faults.

It will be appreciated that one or more additional components may be incorporated, modified, or omitted in the implementation of the present disclosure without departing from the scope as defined by the appended claims. The described embodiments are merely illustrative, and variations in design, structure, or material selection may be made to suit specific applications. Any such modifications, equivalents, or substitutions are intended to be within the scope and spirit of the present invention as defined by the claims.

While the foregoing describes various embodiments of the present disclosure, other and further embodiments of the present disclosure may be devised without departing from the basic scope thereof. The scope of the present disclosure is determined by the claims that follow. The present disclosure is not limited to the described embodiments, versions, or examples, which are included to enable a person having ordinary skill in the art to make and use the present disclosure when combined with information and knowledge available to the person having ordinary skill in the art.

We claim:

1. A chiplet-based smart integrated compute system comprising:
a safe compute subsystem configured to execute high-power compute operations and perform secure data exchange with external devices;
a safe compute and safety monitoring subsystem configured to execute safety-critical operations and perform real-time safety monitoring independently of the safe compute subsystem;
a plurality of dedicated secondary storage subsystems operatively coupled to the safe compute subsystem and the safe compute and safety monitoring subsystem, wherein each dedicated secondary storage subsystem is configured to provide volatile memory through a respective memory controller;
a plurality of clock-generation subsystems configured to provide independent timing references to each subsystem;
a plurality of power-regulation subsystems configured to provide independent regulated power to each subsystem; and
a safe smart power management subsystem comprising one or more power-management integrated circuits and a microcontroller configured to perform intelligent power distribution to the safe compute subsystem, the safe compute and safety monitoring subsystem, and the plurality of dedicated secondary storage subsystems via respective power-regulation subsystems, and selectively isolate a faulty chiplet or a faulty power-regulation subsystem;
wherein each of the subsystems is interconnected by die-to-die interconnects within a unified package to provide high-speed communication, reduced latency, and freedom from interference among the subsystems.

2. The chiplet-based smart integrated compute system of claim 1, wherein the microcontroller of the safe smart power management subsystem is further configured to manage power-on and reset sequences of the chiplet-based smart integrated compute system independently of any external microcontroller.

3. The chiplet-based smart integrated compute system of claim 1, wherein the microcontroller is configured to perform firmware or software updates to the one or more power-management integrated circuits over-the-air through a secure network connection.

4. The chiplet-based smart integrated compute system of claim 1, wherein each of the safe compute subsystem and the safe compute and safety monitoring subsystem comprises a dedicated secondary storage subsystem comprising volatile memory configured to store temporary operational data for the respective subsystem.

5. The chiplet-based smart integrated compute system of claim 1, wherein each of the plurality of clock-generation subsystems comprises a crystal oscillator configured to provide a timing reference to a respective one of the safe compute subsystem, the safe compute and safety monitoring subsystem, or the plurality of dedicated secondary storage subsystems.

6. The chiplet-based smart integrated compute system of claim 1, wherein each of the plurality of power-regulation subsystems comprises a pre-regulator configured to provide regulated voltage to a respective one of the safe compute subsystem, the safe compute and safety monitoring subsystem, or the plurality of dedicated secondary storage subsystems.

7. The chiplet-based smart integrated compute system of claim 1, wherein the die-to-die interconnects comprise high-speed serial interfaces configured to facilitate secure data exchange among the plurality of subsystems integrated on a same substrate.

8. The chiplet-based smart integrated compute system of claim 1, wherein the microcontroller is further configured to monitor thermal and electrical parameters of each of the subsystems across the chiplet-based smart integrated compute system and perform selective shutdown of at least one subsystem exhibiting a fault condition.

9. The chiplet-based smart integrated compute system of claim 1, wherein the safe compute subsystem is configured to serve as a secure communication gateway for external electronic control units via a wireless communication network.

10. The chiplet-based smart integrated compute system of claim 1, wherein the safe compute subsystem comprises a cryptographic processing unit configured to perform encryption and decryption of data exchanged between the chiplet-based smart integrated compute system and the external electronic control units, using hardware-embedded secure keys.

11. The chiplet-based smart integrated compute system of claim 1, wherein the microcontroller is configured to transmit diagnostic telemetry data comprising health and performance data of the power-management integrated circuits and all the subsystems to a remote server for predictive maintenance.
